(19) United States
(12) Patent Application Publication
(10) Pub. No.: US 2026/0112904 A1
(43) Pub. Date: Apr. 23, 2026

(54) IN-VEHICLE POWER SUPPLY APPARATUS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Takahiro OKAMOTO, Osaka (JP); Hiroki SHIMODA, Osaka (JP); Taiji YANAGIDA, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 19/134,811

(22) PCT Filed: Nov. 22, 2023
(86) PCT No.: PCT/JP2023/041972

§ 371 Date: Jun. 2, 2025

(30) Foreign Application Priority Data
Dec. 13, 2022 (JP) 2022-198517

(51) Int. Cl. H02J 7/62; B60L 3/00; H02J 7/00; H02J 7/34

(52) U.S. Cl. CPC H02J 7/62; B60L 3/0046; H02J 7/342; H02J 7/345; H02J 7/855; H02J 2207/50

(57) ABSTRACT

An in-vehicle power supply apparatus is used in an in-vehicle power supply system. The in-vehicle power supply system includes a battery, a capacitor, and a power path provided between the battery and the capacitor. The in-vehicle power supply apparatus includes a plurality of relay circuits provided on the power path between the battery and the capacitor, each relay circuit including a relay and a parallel circuit provided in parallel to the relay. The parallel circuit has a configuration in which a parallel relay and a resistor unit are connected in series.

### TECHNICAL FIELD

The present disclosure relates to an in-vehicle power supply apparatus.

### BACKGROUND ART

Patent Document 1 discloses a battery system that has a configuration in which, after pre-charging performed by a pre-charge circuit, a relay that electrically connects a load apparatus and a battery is closed. With this configuration, an inrush current that flows through the relay when the relay is closed is suppressed.

### CITATION LIST

### Patent Documents

Patent Document 1: JP 2020-78196A

### SUMMARY OF INVENTION

### Technical Problem

However, even when the inrush current is suppressed, the relay deteriorates by being repeatedly turned on and off. When the deterioration of the relay progresses, the relay eventually becomes unusable, which requires a replacement of an apparatus that includes the relay.

It is an object of the present disclosure to provide a technique, with which the extension of the service life of an apparatus that includes a relay can be easily achieved.

### Solution to Problem

An in-vehicle power supply apparatus according to the present disclosure is an in-vehicle power supply apparatus used in an in-vehicle power supply system including a battery, a capacitor, and a power path provided between the battery and the capacitor, the in-vehicle power supply apparatus including: a plurality of relay circuits provided on the power path between the battery and the capacitor, each relay circuit including a relay and a parallel circuit provided in parallel to the relay, wherein the parallel circuit has a configuration in which a parallel relay and a resistor unit are connected in series.

### Advantageous Effects of Invention

With the technique according to the present disclosure, it is possible to easily achieve the extension of the service life of an apparatus that includes a relay.

### BRIEF DESCRIPTION OF DRAWINGS

FIG. 1 is a circuit diagram schematically showing an in-vehicle power supply system that includes an in-vehicle power supply apparatus according to Embodiment 1.

FIG. 2 is a diagram illustrating an operation when the in-vehicle power supply apparatus selects a first relay circuit as a switch target relay circuit and then executes first control.

FIG. 3 is a diagram illustrating an operation when the in-vehicle power supply apparatus executes second control.

FIG. 4 is a diagram illustrating an operation when the in-vehicle power supply apparatus selects a second relay circuit as a switch target relay circuit and then executes first control.

FIG. 5 is a flowchart illustrating a flow of processing performed by the in-vehicle power supply apparatus according to Embodiment 1.

FIG. 6 is a circuit diagram schematically showing an in-vehicle power supply system that includes an in-vehicle power supply apparatus according to embodiment 2.

FIG. 7 is a circuit diagram schematically showing an in-vehicle power supply system that includes an in-vehicle power supply apparatus according to Embodiment 3.

### DESCRIPTION OF EMBODIMENT

First, embodiments according to the present disclosure will be listed and described.

[1] An in-vehicle power supply apparatus used in an in-vehicle power supply system including a battery, a capacitor, and a power path provided between the battery and the capacitor, the in-vehicle power supply apparatus including: a plurality of relay circuits provided on the power path between the battery and the capacitor, each relay circuit including a relay and a parallel circuit provided in parallel to the relay, wherein the parallel circuit has a configuration in which a parallel relay and a resistor unit are connected in series.

The in-vehicle power supply apparatus described above can pre-charge the capacitor using the parallel circuit of one of the plurality of relay circuits while suppressing electric current. Also, by switching the relay of the relay circuit to be on after pre-charging the capacitor, the in-vehicle power supply apparatus described above can prevent an inrush current from flowing into the relay. Moreover, the in-vehicle power supply apparatus described above can selectively use the relay to be switched on after pre-charging the capacitor from among the relays of the plurality of relay circuits. Accordingly, the extension of the service life of the apparatus that includes the relays can be easily achieved.

[2] The in-vehicle power supply apparatus according to clause [1], including: a control unit configured to control the plurality of relay circuits, wherein the plurality of relay circuits are provided in series to each other on the power path, and the control unit executes first control when a start condition for starting charging/discharging of the battery is satisfied, and executes second control when a switch condition is satisfied during execution of the first control, the first control being control to switch the parallel relay of a switch target relay circuit out of the plurality of relay circuits to be on and switch the relay of a non-switch target relay circuit out of the plurality of relay circuits to be on, and the second control being control to switch the relay of the switch target relay circuit to be on.

With the configuration in which the plurality of relay circuits are provided in series, by executing the first control, the in-vehicle power supply apparatus described above can pre-charge the capacitor. Also, by executing the second control after pre-charging the capacitor, the in-vehicle power supply apparatus described above can prevent an inrush current from flowing into the relay.

[3] The in-vehicle power supply apparatus according to clause [1], including: a control unit configured to control the plurality of relay circuits, wherein the plurality of relay circuits are provided in parallel to each other on the power path, and when a start condition for starting charging/discharging of the battery is satisfied, the control unit performs control to switch the parallel relay of at least one of the plurality of relay circuits to be on, and thereafter switch the relay of a switch target relay circuit out of the plurality of relay circuits to be on.

With the configuration in which the plurality of relay circuits are provided in parallel, by performing control to switch the parallel relay of at least one of the plurality of relay circuits to be on, the in-vehicle power supply apparatus described above can pre-charge the capacitor. Also, by switching the relay of the switch target relay circuit after pre-charging the capacitor, the in-vehicle power supply apparatus described above can prevent an inrush current from flowing into the relay.

[4] The in-vehicle power supply apparatus according to clause [2] or [3], wherein the control unit compares a degree of deterioration between the relays of the plurality of relay circuits, and selects the switch target relay circuit based on a result of the comparison.

The in-vehicle power supply apparatus described above can reflect the result of comparison of the degree of deterioration between the relays when selecting the switch target relay circuit.

[5] The in-vehicle power supply apparatus according to clause [4], wherein the control unit selects, as the switch target relay circuit, one of the plurality of relay circuits whose relay has a lowest degree of deterioration.

With the in-vehicle power supply apparatus described above, the relays are likely to deteriorate evenly. Accordingly, the extension of the service life of the apparatus that includes the relays can be more reliably achieved.

[6] The in-vehicle power supply apparatus according to clause [4] or [5], wherein, for each of the relays of the plurality of relay circuits, the control unit specifies, as the degree of deterioration, a resistance value when the relay is on.

With the in-vehicle power supply apparatus described above, the resistance value when each of the relays of the plurality of relay circuits is on can be used as the degree of deterioration.

[7] The in-vehicle power supply apparatus according to clause [2] or [3], wherein the control unit selects the switch target relay circuit according to a predetermined order.

The in-vehicle power supply apparatus described above selects the switch target relay circuit according to a predetermined order. Accordingly, the relays are likely to deteriorate evenly.

[8] The in-vehicle power supply apparatus according to any one of clauses [2], [4], and [7], wherein the power path includes a positive electrode power line that is provided between a positive electrode of the battery and one end of the capacitor and a negative electrode power line that is provided between a negative electrode of the battery and another end of the capacitor, and the plurality of relay circuits include the relay circuit that is provided on the positive electrode power line and the relay circuit that is provided on the negative electrode power line.

With the in-vehicle power supply apparatus described above, the relays can be provided on the positive electrode power line and the negative electrode power line, and the plurality of relay circuits can be configured using the relays provided on the positive electrode power line and the negative electrode power line.

### Embodiment 1

### 1. Configuration of In-Vehicle Power Supply System 100

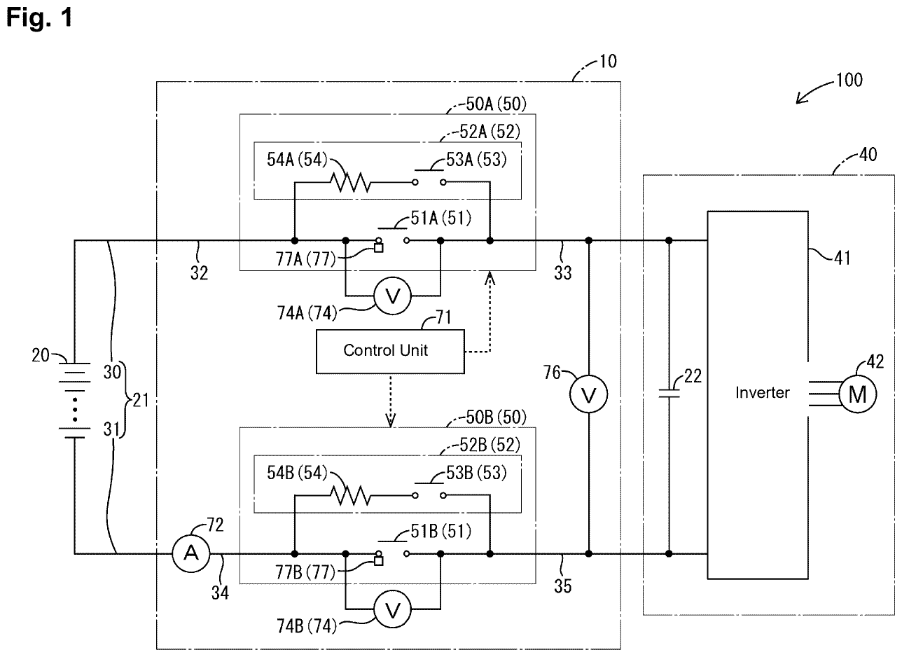

FIG. 1 shows an in-vehicle power supply system 100 that includes an in-vehicle power supply apparatus 10. The in-vehicle power supply system 100 is used in a vehicle (not shown). The vehicle may be an electric car, an engine car, or a hybrid car. The in-vehicle power supply system 100 includes, in addition to the in-vehicle power supply apparatus 10, a battery 20, a power path 21, and a capacitor 22.

The battery 20 may be a lithium ion battery, a lead acid battery, or any other battery.

The power path 21 is an electric path to which electric power based on the battery 20 is supplied. The power path 21 is provided between the battery 20 and the capacitor 22. The power path 21 includes a positive electrode power line 30 and a negative electrode power line 31. The positive electrode power line 30 is provided between a positive electrode of the battery 20 and one end of the capacitor 22. The positive electrode power line 30 is electrically connected to a positive electrode terminal of the battery 20. The negative electrode power line 31 is provided between a negative electrode of the battery 20 and another end of the capacitor 22. The negative electrode power line 31 is electrically connected to a negative electrode terminal of the battery 20. The negative electrode terminal of the battery 20 is electrically connected to the ground. An output voltage from the battery 20 is applied to the power path 21 (more specifically, the positive electrode power line 30). In the specification of the present application, unless otherwise stated, the term “voltage” refers to a potential difference relative to the ground potential.

The capacitor 22 is electrically connected to the power path 21. The capacitor 22 is provided between the positive electrode power line 30 and the negative electrode power line 31. The one end of the capacitor 22 is electrically connected to the positive electrode power line 30. The other end of the capacitor 22 is electrically connected to the negative electrode power line 31. The electric power based on the battery 20 is supplied to the capacitor 22 via the power path 21. The capacitor 22 smooths the voltage applied to the power path 21 based on the battery 20.

In the present embodiment, the capacitor 22 is configured as a part of a driving unit 40 that is included in the in-vehicle power supply system 100. The driving unit 40 includes, in addition to the capacitor 22, an inverter 41 and a motor 42. The capacitor 22 is provided at a position closer to the battery 20 relative to the inverter 41. The capacitor 22 smooths the voltage based on the battery 20 and supplies the smoothed voltage to the inverter 41. The inverter 41 is electrically connected to the power path 21. The inverter 41 generates AC voltage (for example, three-phase AC voltage) from DC voltage that is based on the voltage supplied from the battery 20, and supplies the generated AC voltage to the motor 42. The motor 42 is, for example, a main engine motor. The motor 42 is a device that rotates based on the electric power supplied from the battery 20 to exert a rotational force on the wheels of the vehicle.

The in-vehicle power supply apparatus 10 is used in the in-vehicle power supply system 100. The in-vehicle power supply apparatus 10 includes a plurality of relay circuits 50. Each relay circuit 50 includes a relay 51 and a parallel circuit 52 provided in parallel to the relay 51. Each relay 51 is a mechanical relay that has contact points. The parallel circuit 52 is connected to the relay 51 in parallel. The parallel circuit 52 has a configuration in which a parallel relay 53 and a resistor unit 54 are connected in series. The parallel relay 53 may be a mechanical relay that has contact points, or a relay that includes a semiconductor switch such as a field effect transistor (FET). The resistor unit 54 is configured using, for example, a known resistor.

The plurality of relay circuits 50 are provided on the power path 21 between the battery 20 and the capacitor 22. The plurality of relay circuits 50 are provided in series on the power path 21. The plurality of relay circuits 50 include a first relay circuit 50A that is provided on the positive electrode power line 30 and a second relay circuit 50B that is provided on the negative electrode power line 31.

The first relay circuit 50A includes a first relay 51A that corresponds to an example of the relay 51 and a first parallel circuit 52A that corresponds to an example of the parallel circuit 52. The first relay 51A is provided between the battery 20 (more specifically, the positive electrode of the battery 20) and the capacitor 22 (more specifically, the one end of the capacitor 22). The first relay 51A causes the battery 20 (more specifically, the positive electrode of the battery 20) and the capacitor 22 (more specifically, the one end of the capacitor 22) to electrically communicate with each other when the first relay 51A is on, and interrupts the electrical communication between the battery 20 (more specifically, the positive electrode of the battery 20) and the capacitor 22 (more specifically, the one end of the capacitor 22) when the first relay 51A is off. The first relay 51A is a system main relay. The first parallel circuit 52A has a configuration in which a first parallel relay 53A and a first resistor unit 54A are connected in series. The first parallel relay 53A corresponds to an example of the parallel relay 53. The first resistor unit 54A corresponds to an example of the resistor unit 54.

The positive electrode power line 30 includes a first positive electrode power line 32 that is provided at a position closer to the battery 20 relative to the first relay 51A and a second positive electrode power line 33 that is provided at a position closer to the capacitor 22 relative to the first relay 51A. One end of the first positive electrode power line 32 is electrically connected to the positive electrode terminal of the battery 20. Another end of the first positive electrode power line 32 is electrically connected to one end of the first relay 51A. One end of the second positive electrode power line 33 is electrically connected to another end of the first relay 51A Another end of the second positive electrode power line 33 is electrically connected to the one end of the capacitor 22.

The one end of the first relay 51A is electrically connected to the positive electrode terminal of the battery 20, with a configuration in which it is short-circuited with the positive electrode terminal of the battery 20. The other end of the first relay 51A is electrically connected to the one end of the capacitor 22, with a configuration in which it is short-circuited with the one end of the capacitor 22. When the first relay 51A is on, the first positive electrode power line 32 and the second positive electrode power line 33 electrically communicate with each other via the first relay 51A. When the first relay 51A is off, the electrical communication between the first positive electrode power line 32 and the second positive electrode power line 33 via the first relay 51A is interrupted. One end of the first parallel circuit 52A is electrically connected to the first positive electrode power line 32, with a configuration in which it is short-circuited with the first positive electrode power line 32. That is, the one end of the first parallel circuit 52A is electrically connected to the positive electrode terminal of the battery 20 and the one end of the first relay 51A, with a configuration in which it is short-circuited with the positive electrode terminal of the battery 20 and the one end of the first relay 51A. Another end of the first parallel circuit 52A is electrically connected to the second positive electrode power line 33, with a configuration in which it is short-circuited with the second positive electrode power line 33. That is, the other end of the first parallel circuit 52A is electrically connected to the other end of the first relay 51A and the one end of the capacitor 22, with a configuration in which it is short-circuited with the other end of the first relay 51A and the one end of the capacitor 22.

The second relay circuit 50B includes a second relay 51B that corresponds to an example of the relay 51 and a second parallel circuit 52B that corresponds to an example of the parallel circuit 52. The second relay 51B is provided between the battery 20 (more specifically, the negative electrode of the battery 20) and the capacitor 22 (more specifically, the other end of the capacitor 22). The second relay 51B causes the battery 20 (more specifically, the negative electrode of the battery 20) and the capacitor 22 (more specifically, the other end of the capacitor 22) to electrically communicate with each other when the second relay 51B is on, and interrupts the electrical communication between the battery 20 (more specifically, the negative electrode of the battery 20) and the capacitor 22 (more specifically, the other end of the capacitor 22) when the second relay 51B is off. The second relay 51B is a system main relay. The second parallel circuit 52B has a configuration in which a second parallel relay 53B and a second resistor unit 54B are connected in series. The second parallel relay 53B corresponds to an example of the parallel relay 53. The second resistor unit 54B corresponds to an example of the resistor unit 54.

The negative electrode power line 31 includes a first negative electrode power line 34 that is provided at a position closer to the battery 20 relative to the second relay 51B and a second negative electrode power line 35 that is provided at a position closer to the capacitor 22 relative to the second relay 51B. One end of the first negative electrode power line 34 is electrically connected to the negative electrode terminal of the battery 20. Another end of the second negative electrode power line 35 is electrically connected to one end of the second relay 51B. One end of the second negative electrode power line 35 is electrically connected to another end of the second relay 51B. Another end of the second negative electrode power line 35 is electrically connected to the other end of the capacitor 22.

The one end of the second relay 51B is electrically connected to the negative electrode terminal of the battery 20, with a configuration in which it is short-circuited with the negative electrode terminal of the battery 20. The other end of the second relay 51B is electrically connected to the other end of the capacitor 22 with a configuration in which it is short-circuited with the other end of the capacitor 22. When the second relay 51B is on, the first negative electrode power line 34 and the second negative electrode power line 35 electrically communicate with each other via the second relay 51B. When the second relay 51B is off, the electrical communication between the first negative electrode power line 34 and the second negative electrode power line 35 via the second relay 51B is interrupted. One end of the second parallel circuit 52B is electrically connected to the first negative electrode power line 34, with a configuration in which it is short-circuited with the first negative electrode power line 34. That is, the one end of the second parallel circuit 52B is electrically connected to the negative electrode terminal of the battery 20 and the one end of the second relay 51B, with a configuration in which it is short-circuited with the negative electrode terminal of the battery 20 and the one end of the second relay 51B. Another end of the second parallel circuit 52B is electrically connected to the second negative electrode power line 35, with a configuration in which it is short-circuited with the second negative electrode power line 35. That is, the other end of the second parallel circuit 52B is electrically connected to the other end of the second relay 51B and the other end of the capacitor 22, with a configuration in which it is short-circuited with the other end of the second relay 51B and the other end of the capacitor 22.

### 2. Configuration of Control Unit 71

The in-vehicle power supply apparatus 10 includes a control unit 71, a current detection unit 72, voltage detection units 74, a capacitor voltage detection unit 76, and temperature detection units 77.

The control unit 71 includes, for example, a control circuit such as an integrated circuit. The control unit 71 includes a processor such as a CPU, a storage unit such as a memory, an input/output unit, and the like.

The current detection unit 72 is configured as, for example, a known current sensor. The current detection unit 72 detects the current value of an electric current that flows through the power path 21. The current detection unit 72 detects the current value of an electric current that flows through the power path 21 excluding the relay circuits 50. The current detection unit 72 detects the current value of an electric current that flows through the first parallel circuit 52A when the first parallel relay 53A is on and the second relay 51B is on. Also, the current detection unit 72 detects the current value of an electric current that flows through the second parallel circuit 52B when the second parallel relay 53B is on and the first relay 51A is on. The current detection unit 72 outputs a signal that can specify the detected value. The control unit 71 specifies the current value of an electric current that flows through the power path 21 (more specifically, the power path 21 excluding the relay circuits 50) based on the output signal from the current detection unit 72. The control unit 71 specifies the detected value when the capacitor 22 is charged using the first parallel circuit 52A, and thereby specifies the current value of an electric current that flows through the first parallel circuit 52A. Also, the control unit 71 specifies the detected value when the capacitor 22 is charged using the second parallel circuit 52B, and thereby specifies the current value of an electric current that flows through the second parallel circuit 52B.

The voltage detection units 74 are configured as, for example, known voltage detection circuits. The voltage detection units 74 are separately provided to the relays 51, and each voltage detection unit 74 detects the potential difference between the terminals of the corresponding relay 51. The voltage detection units 74 include a first voltage detection unit 74A that is provided to the first relay 51A and a second voltage detection unit 74B that is provided to the second relay 51B. Each voltage detection unit 74 outputs a signal that can specify the detected value. Each control unit 71 specifies the potential difference between the terminals of each relay 51 based on the output signal from the corresponding voltage detection unit 74.

The capacitor voltage detection unit 76 is configured as, for example, a known voltage detection circuit. The capacitor voltage detection unit 76 detects a voltage of the capacitor 22. The capacitor voltage detection unit 76 outputs a signal that can specify the detected value. The control unit 71 specifies the voltage of the capacitor 22 based on the output signal from the capacitor voltage detection unit 76.

The temperature detection units 77 are separately provided to the relays 51, and each temperature detection unit 77 detects the contact point temperature in the corresponding relay 51 when the relay 51 is on. The temperature detection units 77 include a first temperature detection unit 77A that is provided to the first relay 51A and a second temperature detection unit 77B that is provided to the second relay 51B. Each temperature detection unit 77 outputs a signal that can specify the detected value. The control unit 71 specifies the contact point temperature in each relay 51 when the relay 51 is on based on the output signal from the corresponding temperature detection unit 77.

The control unit 71 controls the first relay circuit 50A and the second relay circuit 50B. That is, the control unit 71 controls the first relay 51A, the first parallel relay 53A, the second relay 51B, and the second parallel relay 53B.

The control unit 71 executes first control when a start condition for starting charging/discharging of the battery 20 is satisfied. The start condition may be that, for example, the vehicle has been switched to a start state. As used herein, the term “start state” of the vehicle refers to, for example, a state in which a starting switch (for example, an ignition switch, a power switch, or the like) is switched to on. By acquiring, for example, an on/off signal that indicates whether the starting switch is on or off directly or indirectly via another control device, the control unit 71 determines that the starting switch is on or off.

At the time when the start condition is satisfied, the first relay 51A, the first parallel relay 53A, the second relay 51B, and the second parallel relay 53B are off. The first control is control for charging the capacitor 22 using one of the parallel circuits 52 while suppressing electric current. The first control includes control to switch the parallel relay 53 of a switch target relay circuit 50 out of the plurality of relay circuits 50 to be on and switch the relay 51 of a non-switch target relay circuit 50 out of the plurality of relay circuits 50 to be on. More specifically, the first control includes, for the switch target relay circuit 50 out of the plurality of relay circuits 50, control to switch the parallel relay 53 of the switch target relay circuit 50 to be on while maintaining the relay 51 of the switch target relay circuit 50 in the off state, and, for the non-switch target relay circuit 50, control to switch the relay 51 of the non-switch target relay circuit 50 to be on while maintaining the parallel relay 53 of the non-switch target relay circuit 50 in the off state. As a result of the first control being executed, the capacitor 22 is charged while the electric current is suppressed by the resistor unit 54, and the voltage of the capacitor 22 gradually increases. As the voltage of the capacitor 22 increases, the difference between the voltage of the capacitor 22 and the voltage of the battery 20 decreases. As a result, the potential difference between the terminals of the relay 51 of the switch target relay circuit 50 is reduced.

The control unit 71 executes second control when a switch condition is satisfied during execution of the first control. The second control is control for switching the relay 51 of the switch target relay circuit 50 to be on. The second control includes, for the non-switch target relay circuit 50, control to maintain the parallel relay 53 of the non-switch target relay circuit 50 in the off state while maintaining the relay 51 of the non-switch target relay circuit 50 in the on state, and for the switch target relay circuit 50, control to switch the relay 51 of the switch target relay circuit 50 to be on and switch the parallel relay 53 of the switch target relay circuit 50 to be off. The parallel relay 53 is switched to be off preferably at a timing after the timing at which the relay 51 is switched to be on. As a result of the second control being executed, more power is supplied from the battery 20 side toward the capacitor 22 side.

The switch condition may be that the potential difference between the terminals of the relay 51 of the switch target relay circuit 50 is less than or equal to a predetermined value, the current value of an electric current that flows through the parallel relay 53 of the switch target relay circuit 50 is less than or equal to a predetermined value, a predetermined period of time has passed from the start of the first control, the voltage of the capacitor 22 is greater than or equal to a predetermined value, or any other condition.

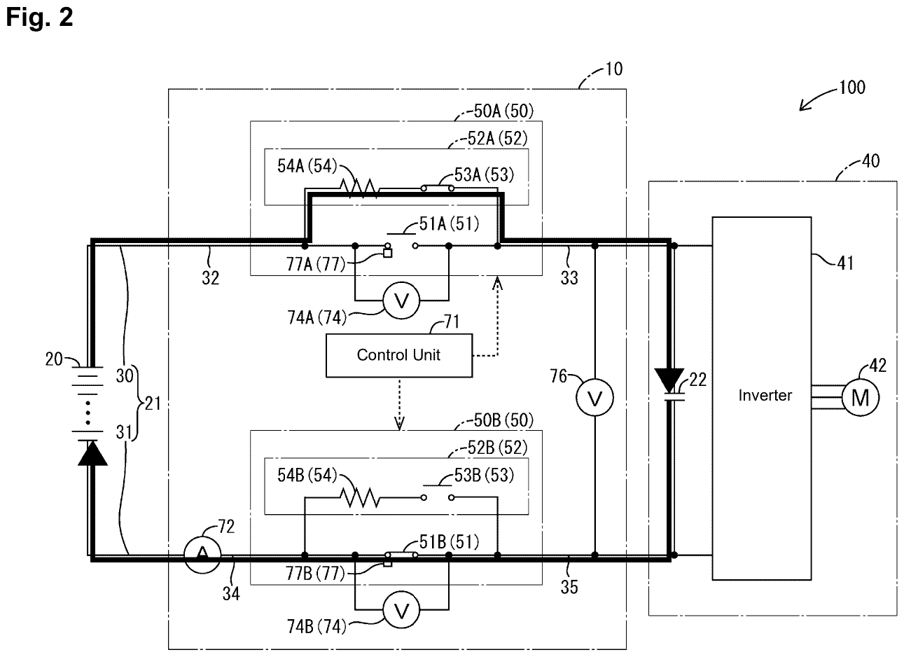

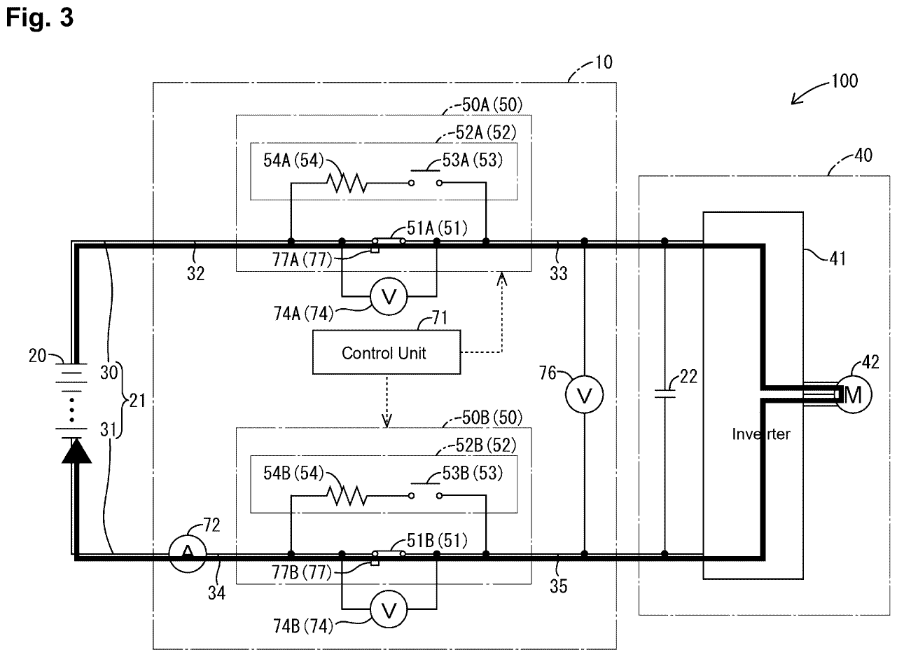

In the case where the switch target relay circuit 50 is the first relay circuit 50A, the control unit 71 executes the first control and the second control in the manner described below. In the first control, the control unit 71 performs control to switch the first parallel relay 53A of the first relay circuit 50A to be on and switch the second relay 51B of the second relay circuit 50B to be on. More specifically, the control unit 71 switches the first parallel relay 53A to be on while maintaining the first relay 51A in the off state, and switches the second relay 51B to be on while maintaining the second parallel relay 53B in the off state. By doing so, as shown in FIG. 2, the electric current from the battery 20 is supplied to the capacitor 22 while being suppressed by the first resistor unit 54A. When the switch condition is satisfied during execution of the first control, the control unit 71 executes the second control. In the second control, the control unit 71 switches the first relay 51A of the first relay circuit 50A to be on. More specifically, the control unit 71 switches the first relay 51A to be on and the first parallel relay 53A to be off while maintaining the second relay 51B in the on state and the second parallel relay 53B in the off state. By doing so, as shown in FIG. 3, the first relay 51A can be switched to be on while preventing an inrush current from flowing into the first relay 51A. Accordingly, more power is supplied from the battery 20 side toward the capacitor 22 side.

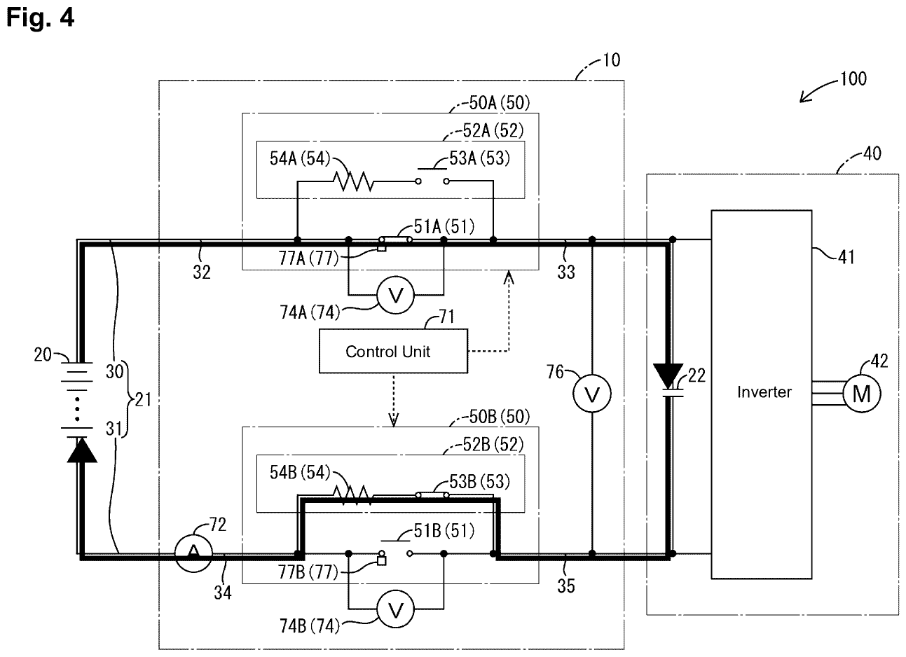

In the case where the switch target relay circuit 50 is the second relay circuit 50B, the control unit 71 executes the first control and the second control in the manner described below. In the first control, the control unit 71 performs control to switch the second parallel relay 53B of the second relay circuit 50B to be on and switch the first relay 51A of the first relay circuit 50A to be on. More specifically, the control unit 71 switches the second parallel relay 53B to be on while maintaining the second relay 51B in the off state, and switches the first relay 51A to be on while maintaining the first parallel relay 53A in the off state. By doing so, as shown in FIG. 4, the electric current from the battery 20 is supplied to the capacitor 22 while being suppressed by the second resistor unit 54B. When the switch condition is satisfied during execution of the first control, the control unit 71 executes the second control. In the second control, the control unit 71 switches the second relay 51B of the second relay circuit 50B to be on. More specifically, the control unit 71 switches the second relay 51B to be on while maintaining the first relay 51A in the on state and the first parallel relay 53A in the off state, and switches the second parallel relay 53B to be off. By doing so, the second relay 51B can be switched to be on while preventing an inrush current from flowing into the second relay 51B. Accordingly, more power is supplied from the battery 20 side toward the capacitor 22 side.

The control unit 71 compares the degree of deterioration between the relays 51 of the plurality of relay circuits 50, and selects a switch target relay circuit 50 based on a result of the comparison. The control unit 71 selects, as the switch target relay circuit 50, one of the plurality of relay circuits 50 whose relay 51 has the lowest degree of deterioration.

### 3. Degree of Deterioration

The degree of deterioration of each relay 51 is specified based on, for example, the potential difference between the terminals of the relay 51 when the relay 51 is on, the resistance value when the relay 51 is on, the number of operations of the relay 51, the temperature (more specifically, the contact point temperature in the relay) when the relay 51 is on, a plurality of combinations thereof, or the like. The degree of deterioration of each relay 51 may be any one of these values, or a value obtained by substituting any one of these values into an arithmetic expression.

The degree of deterioration of each relay 51 increases as the potential difference between the terminals of the relay 51 increases. The degree of deterioration of each relay 51 increases as the resistance value when the relay 51 is on increases. The degree of deterioration of each relay 51 increases as the number of operations of the relay 51 increases. If it is assumed that the current value of the electric current that flows through the relay 51 is constant, the degree of deterioration of each relay 51 increases as the temperature when the relay 51 is on increases.

As a method for specifying the potential difference between the terminals of the relay 51, for example, the control unit 71 specifies the potential difference between the terminals of the first relay 51A and the potential difference between the terminals of the second relay 51B during execution of the second control (that is, when the first relay 51A and the second relay 51B are on).

As a method for specifying the resistance value when the relay 51 is on, for example, the control unit 71 specifies the potential difference between the terminals of the first relay 51A and the potential difference between the terminals of the second relay 51B and the current value of the electric current that flows through the power path 21 during execution of the second control (that is, when the first relay 51A and the second relay 51B are on). Then, the control unit 71 specifies the resistance value of each relay 51 based on the specified potential differences and the specified current value. As used herein, the term “during execution of the second control” refers to a period of time after execution of the first control, or in other words, after the vehicle has been switched to the start state.

As a method for specifying the number of operations of the relay 51, for example, the control unit 71 counts, for each relay 51, the number of times the relay 51 is switched to on in the second control.

As a method for specifying the contact point temperature in each relay 51 when the relay 51 is on, for example, the control unit 71 specifies the contact point temperature in each relay 51 when the relay 51 is on based on the output signal from the corresponding temperature detection unit 77 during execution of the second control (that is, when the first relay 51A and the second relay 51B are on).

### 4. Operation of In-Vehicle Power Supply Apparatus 10

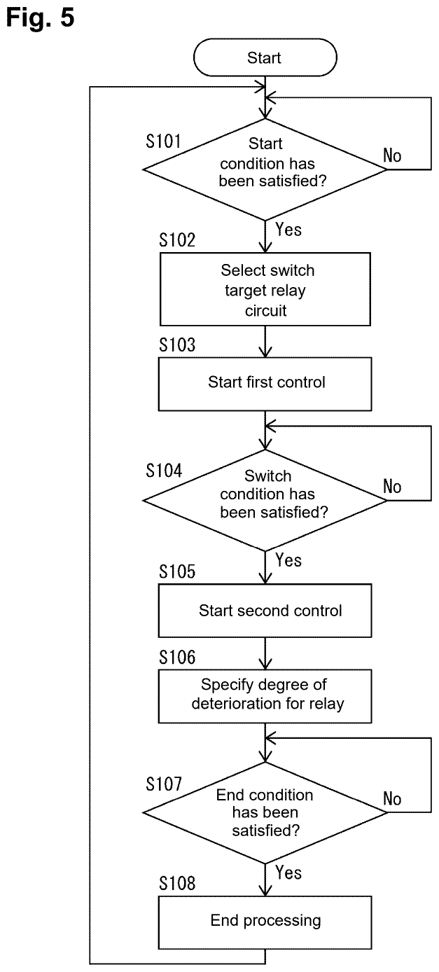

The control unit 71 starts the processing shown in FIG. 5 at the activation of, for example, a control circuit that constitutes the control unit 71. In step S101, the control unit 71 determines whether the start condition for starting charging/discharging of the battery 20 has been satisfied. If it is determined that the start condition has not been satisfied (No in step S101), the control unit 71 repeats the processing in step S101 until the start condition is satisfied. If it is determined that the start condition has been satisfied (Yes in step S101), in step S102, the control unit 71 selects a switch target relay circuit 50.

The control unit 71 selects a switch target relay circuit 50 based on the degree of deterioration of each relay 51 specified in the processing in the previous step S106. That is, the control unit 71 selects a switch target relay circuit 50 based on the degree of deterioration of each relay 51 specified during execution of the previous second control. When selecting a switch target relay circuit 50 for the first time, the control unit 71 selects a predetermined relay circuit 50 as the switch target relay circuit 50.

After selecting the switch target relay circuit 50, in step S103, the control unit 71 starts the above-described first control. After the start of the first control, in step S104, the control unit 71 determines whether the above-described switch condition has been satisfied. If it is determined that the switch condition has not been satisfied (No in step S104), the control unit 71 repeats the processing in step S104 until the switch condition is satisfied. If it is determined that the switch condition has been satisfied (Yes in step S104), in step S105, the control unit 71 starts the above-described second control.

After the start of the second control, in step S106, the control unit 71 specifies the degree of deterioration for each relay 51. After specifying the degree of deterioration for each relay 51, in step S107, the control unit 71 determines whether an end condition has been satisfied. The end condition is a condition for ending charging/discharging of the battery 20. If it is determined that the end condition has not been satisfied (No in step S107), the control unit 71 repeats the processing in step S107 until the end condition is satisfied. If it is determined that the end condition has been satisfied (Yes in step S107), in step S108, the control unit 71 performs end processing. The end processing is, for example, processing for controlling to switch all of the relays and the parallel relays (in the present embodiment, all of the first relay 51A, the first parallel relay 53A, the second relay 51B, and the second parallel relay 53B) to be off. After the end processing, the control unit 71 returns to the processing in step S101.

### 5. Examples of Advantageous Effects

The in-vehicle power supply apparatus 10 can pre-charge the capacitor 22 using the parallel circuit 52 of one of the plurality of relay circuits 50 while suppressing electric current. Also, by switching the relay 51 of the switch target relay circuit 50 to be on after pre charging the capacitor 22, the in-vehicle power supply apparatus 10 can prevent an inrush current from flowing into the relay 51. Moreover, the in-vehicle power supply apparatus 10 can selectively use the relay 51 to be switched on after pre-charging the capacitor 22 from among the relays 51 of the plurality of relay circuits 50. Accordingly, the extension of the service life of the apparatus that includes the relays 51 can be easily achieved.

With the configuration in which the plurality of relay circuits 50 are provided in series, by executing the first control, the in-vehicle power supply apparatus 10 can pre-charge the capacitor 22 while suppressing electric current. Also, by executing the second control after pre-charging the capacitor, the in-vehicle power supply apparatus 10 can prevent an inrush current from flowing into the relay 51.

The in-vehicle power supply apparatus 10 can reflect the result of comparison of the degree of deterioration between the relays 51 when selecting the switch target relay circuit 50.

With the in-vehicle power supply apparatus 10, the relays 51 are likely to deteriorate evenly. Accordingly, the extension of the service life of the apparatus that includes the relays 51 can be more reliably achieved.

With the in-vehicle power supply apparatus 10, the resistance value when each of the relays 51 of the plurality of relay circuits 50 is on can be used as the degree of deterioration.

With the in-vehicle power supply apparatus 10, the relays 51 can be provided on the positive electrode power line 30 and the negative electrode power line 31, and the plurality of relay circuits 50 can be configured using the relays 51 provided on the positive electrode power line 30 and the negative electrode power line 31.

### Embodiment 2

In Embodiment 2, an example will be described in which the plurality of relay circuits 50 are provided in series on the positive electrode power line 30. In the present embodiment, constituent elements that are the same as those of Embodiment 1 are given the same reference numerals, and the detailed description thereof is omitted.

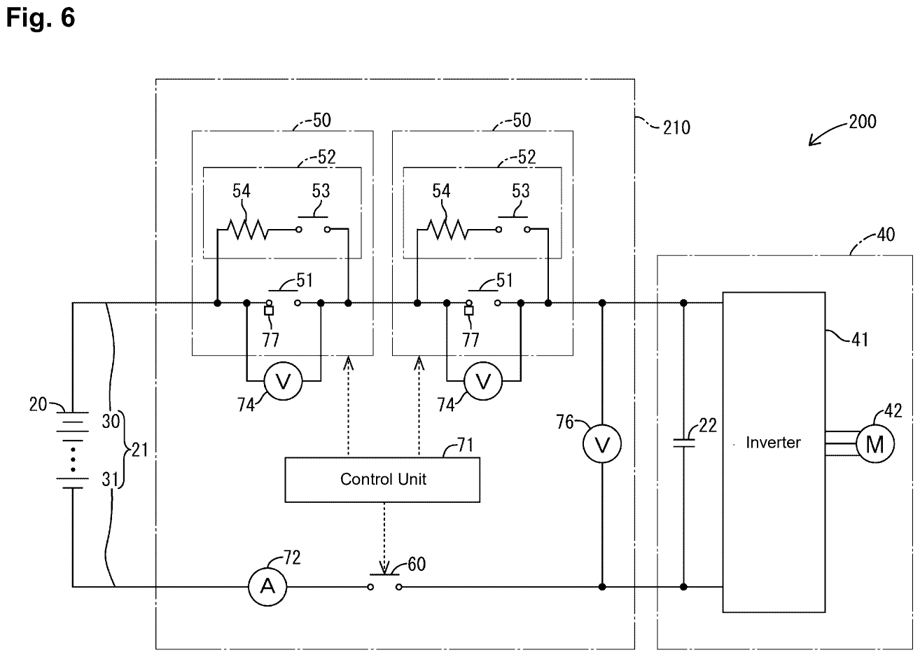

FIG. 6 shows an in-vehicle power supply system 200 that includes an in-vehicle power supply apparatus 210 according to Embodiment 2. The in-vehicle power supply system 200 includes, in addition to the in-vehicle power supply apparatus 210, a battery 20, a power path 21, and a capacitor 22. The in-vehicle power supply apparatus 210 includes a plurality of relay circuits 50, a third relay 60, a control unit 71, a current detection unit 72, voltage detection units 74, a capacitor voltage detection unit 76, and temperature detection units 77. The plurality of relay circuits 50 are provided in series to each other on the positive electrode power line 30.

The third relay 60 is provided on the negative electrode power line 31. The third relay 60 is a system main relay. The third relay 60 is a mechanical relay that has contact points. The third relay 60 is controlled by the control unit 71.

The control unit 71 performs the processing shown in FIG. 5 described in Embodiment 1. However, the present embodiment is different from Embodiment 1 in that the control unit 71 switches the third relay 60 to be on in addition to the operation described in Embodiment 1 when executing the first control in step S103, and also in that the control unit 71 switches the third relay 60 to be off in addition to the operation described in Embodiment 1 when executing the end processing in step S108. Other than the above points, the operation of the control unit 71 is the same as that of the control unit 71 of Embodiment 1.

Even with the in-vehicle power supply apparatus 210 of Embodiment 2, it is possible to pre-charge the capacitor 22 using the parallel circuit 52 of one of the plurality of relay circuits 50 while suppressing electric current. Also, by switching the relay 51 of the relay circuit 50 to be on after pre-charging the capacitor 22, the in-vehicle power supply apparatus 210 can prevent an inrush current from flowing into the relay 51. Moreover, the in-vehicle power supply apparatus 210 can selectively use the relay 51 to be switched on after pre-charging the capacitor 22 from among the relays 51 of the plurality of relay circuits 50. Accordingly, the extension of the service life of the apparatus that includes the relays 51 can be easily achieved.

### Embodiment 3

In Embodiment 3, an example will be described in which the plurality of relay circuits 50 are provided in parallel to each other on the power path 21. In the present embodiment, constituent elements that are the same as those of Embodiment 1 are given the same reference numerals, and the detailed description thereof is omitted.

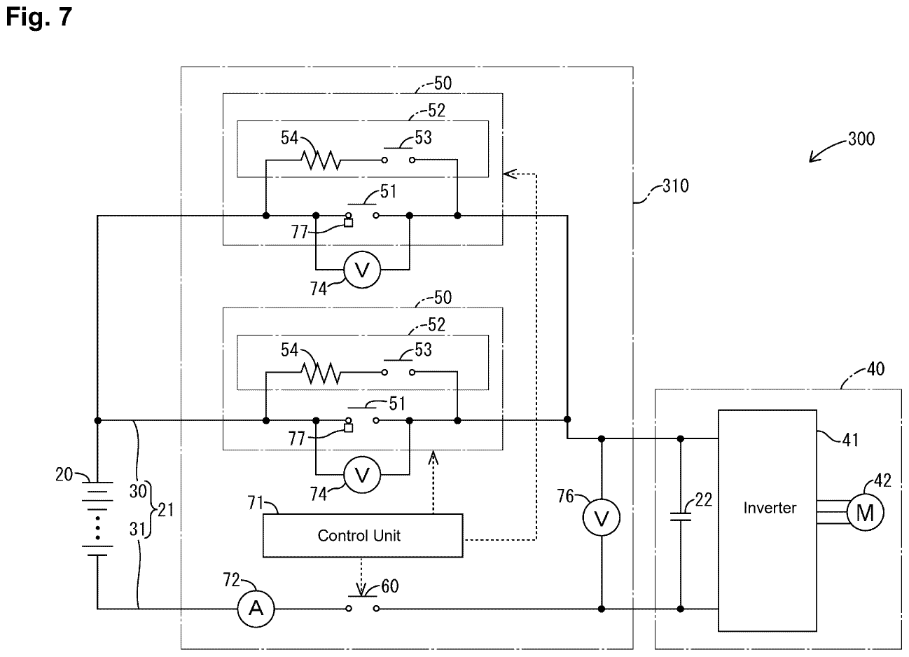

FIG. 7 shows an in-vehicle power supply system 300 that includes an in-vehicle power supply apparatus 310 according to Embodiment 3. The in-vehicle power supply system 300 includes, in addition to the in-vehicle power supply apparatus 310, a battery 20, a power path 21, and a capacitor 22. The in-vehicle power supply apparatus 310 includes a plurality of relay circuits 50, a third relay 60, a control unit 71, a current detection unit 72, voltage detection units 74, a capacitor voltage detection unit 76, and temperature detection units 77. The plurality of relay circuits 50 are provided in parallel to each other on the positive electrode power line 30.

The third relay 60 is provided on the negative electrode power line 31. The third relay 60 is a system main relay. The third relay 60 is a mechanical relay that has contact points. The third relay 60 is controlled by the control unit 71.

If it is determined that the start condition for starting charging/discharging of the battery 20 has been satisfied, the control unit 71 performs control to switch the parallel relay 53 of at least one of the plurality of relay circuits 50 to be on. Also, the control unit 71 performs control to switch the third relay 60 to be on. By doing so, electric power is supplied from the battery 20 to the capacitor 22 via the parallel circuit 52 of one of the plurality of relay circuits 50. That is, the capacitor 22 is charged while suppressing electric current by the resistor unit 54. After that, the control unit 71 switches the relay 51 of a switch target relay circuit 50 out of the plurality of relay circuits 50 to be on. By doing so, more electric current is supplied from the battery 20 side toward the capacitor 22 side.

The control unit 71 performs, for example, the processing shown in FIG. 5 described in Embodiment 1. However, the control unit 71 switches the parallel relay 53 of at least one of the plurality of relay circuits 50 to be on and switches the third relay 60 to be on irrespective of whether the relay circuit is the switch target relay circuit when executing the first control in step S103. Also, the control unit 71 switches the third relay 60 to be off in addition to the operation described in Embodiment 1 when executing the end processing in step S108. Other than the above points, the operation of the control unit 71 is the same as that of the control unit 71 of Embodiment 1.

With the configuration in which the plurality of relay circuits 50 are provided in parallel, by performing control to switch the parallel relay 53 of at least one of the plurality of relay circuits 50 to be on, the in-vehicle power supply apparatus 310 of Embodiment 3 can pre-charge the capacitor 22 while suppressing electric current. Also, by switching the relay 51 of the switch target relay circuit 50 after pre-charging the capacitor 22, the in-vehicle power supply apparatus 310 can prevent an inrush current from flowing into the relay 51.

### Embodiment 4

In Embodiment 4, an example will be described in which the switch target relay circuit 50 is selected according to a predetermined order. An in-vehicle power supply system according to Embodiment 4 will be described with reference to FIG. 1 because constituent elements of the in-vehicle power supply system according to Embodiment 4 are the same as those shown in FIG. 1 described in Embodiment 1.

In Embodiment 4, the control unit 71 selects the switch target relay circuit 50 according to a predetermined order. For example, the control unit 71 may select the first relay circuit 50A and the second relay circuit 50B in this order as the switch target relay circuit 50. The control unit 71 performs, for example, the processing shown in FIG. 5 described in Embodiment 1. The control unit 71 may each time change the switch target relay circuit 50 according to a predetermined order, or may change the switch target relay circuit 50 according to a predetermined order each time a predetermined condition is satisfied. The predetermined condition may be that, for example, the relay 51 of the switch target relay circuit 50 has been switched to be on a predetermined number of times in a row, the degree of deterioration of the relay 51 of the switch target relay circuit 50 has exceeded a threshold value, or any other condition.

The in-vehicle power supply apparatus 10 according to Embodiment 4 selects the switch target relay circuit 50 according to a predetermined order. Accordingly, the relays 51 are likely to deteriorate evenly.

### Other Embodiments

The present disclosure is not limited to the embodiments described based on the foregoing description with reference to the drawings. For example, the features of the embodiments described above or below may be combined in any way unless they are contradictory to each other. Also, any of the features described in the embodiments described above or below may be omitted unless it is clearly stated that the feature is essential. Furthermore, the embodiment given above may be changed as follows.

In the embodiments given above, two relay circuits 50 are used, but the number of relay circuits 50 may be three or more.

In Embodiment 2 given above, the plurality of relay circuits 50 are provided in series on the positive electrode power line 30. However, the plurality of relay circuits 50 are provided in series on the negative electrode power line 31.

In Embodiment 3 given above, the plurality of relay circuits 50 are provided in parallel on the positive electrode power line 30. However, the plurality of relay circuits 50 may be provided in parallel on the negative electrode power line 31.

The embodiments described herein are exemplary in all aspects, and thus should not be construed as limiting. The scope of the invention of the present application is not limited to the embodiments described herein, and all changes that come within the meaning and range of equivalency of the claims are intended to be embraced within the scope of the invention of the present application.

### LIST OF REFERENCE NUMERALS

10 In-vehicle power supply apparatus
20 Battery
21 Power path
22 Capacitor
30 Positive electrode power line
31 Negative electrode power line
32 First positive electrode power line
33 Second positive electrode power line
34 First negative electrode power line
35 Second negative electrode power line
40 Driving unit
41 Inverter
42 Motor
50 Relay circuit
50A First relay circuit
50B Second relay circuit
51 Relay
51A First relay
51B Second relay
52 Parallel circuit
52A First parallel circuit
52B Second parallel circuit
53 Parallel relay
53A First parallel relay
53B Second parallel relay
54 Resistor unit
54A First resistor unit
54B Second resistor unit
60 Third relay
71 Control unit
72 Current detection unit
74 Voltage detection unit
74A First voltage detection unit
74B Second voltage detection unit
76 Capacitor voltage detection unit
77 Temperature detection unit
77A First temperature detection unit
77B Second temperature detection unit
100 In-vehicle power supply system
200 In-vehicle power supply system
210 In-vehicle power supply apparatus
300 In-vehicle power supply system
310 In-vehicle power supply apparatus

1. An in-vehicle power supply apparatus used in an in-vehicle power supply system including a battery, a capacitor, and a power path provided between
the battery and the capacitor,
the in-vehicle power supply apparatus comprising:
a plurality of relay circuits provided on the power path between the battery and the capacitor, each relay circuit including a relay and a parallel circuit provided in parallel to the relay,
wherein the parallel circuit has a configuration in which a parallel relay and a resistor unit are connected in series.

2. The in-vehicle power supply apparatus according to claim 1, comprising:
a control unit configured to control the plurality of relay circuits,
wherein the plurality of relay circuits are provided in series to each other on the power path, and
the control unit executes first control when a start condition for starting charging/discharging of the battery is satisfied, and executes second control when a switch condition is satisfied during execution of the first control, the first control being control to switch the parallel relay of a switch target relay circuit out of the plurality of relay circuits to be on and switch the relay of a non-switch target relay circuit out of the plurality of relay circuits to be on, and the second control being control to switch the relay of the switch target relay circuit to be on.

3. The in-vehicle power supply apparatus according to claim 1, comprising:
a control unit configured to control the plurality of relay circuits,
wherein the plurality of relay circuits are provided in parallel to each other on the power path, and
when a start condition for starting charging/discharging of the battery is satisfied, the control unit performs control to switch the parallel relay of at least one of the plurality of relay circuits to be on, and thereafter switch the relay of a switch target relay circuit out of the plurality of relay circuits to be on.

4. The in-vehicle power supply apparatus according to claim 2,
wherein the control unit compares a degree of deterioration between the relays of the plurality of relay circuits, and selects the switch target relay circuit based on a result of the comparison.

5. The in-vehicle power supply apparatus according to claim 4,
wherein the control unit selects, as the switch target relay circuit, one of the plurality of relay circuits whose relay has a lowest degree of deterioration.

6. The in-vehicle power supply apparatus according to claim 4,
wherein, for each of the relays of the plurality of relay circuits, the control unit specifies, as the degree of deterioration, a resistance value when the relay is on.

7. The in-vehicle power supply apparatus according to claim 2,
wherein the control unit selects the switch target relay circuit according to a predetermined order.

8. The in-vehicle power supply apparatus according to claim 2,
wherein the power path includes a positive electrode power line that is provided between a positive electrode of the battery and one end of the capacitor and a negative electrode power line that is provided between a negative electrode of the battery and another end of the capacitor, and
the plurality of relay circuits include the relay circuit that is provided on the positive electrode power line and the relay circuit that is provided on the negative electrode power line.
